(19) United States
(12) Patent Application Publication
(10) Pub. No.: US 2026/0338672 A1
(43) Pub. Date: Oct. 29, 2026

(54) DEVICES, METHODS, AND SYSTEMS FOR MEASURING AND RECORDING A REACTANT ARRAY

(71) Applicant: SENSILL, INC., Concord, CA (US)

(72) Inventors: William Shea, Martinez, CA (US); Richard Wyeth, Granite Bay, CA (US)

(73) Assignee: SENSILL, INC., Concord, CA (US)

(21) Appl. No.: 19/701,154

(22) Filed: Jun. 8, 2026

Related U.S. Application Data
(63) Continuation of application No. PCT/US2024/058789, filed on Dec. 6, 2024.
(60) Provisional application No. 63/607,926, filed on Dec. 8, 2023.
(60) Provisional application No. 63/607,936, filed on Dec. 8, 2023.
(60) Provisional application No. 63/621,024, filed on Jan. 15, 2024.
(60) Provisional application No. 63/656,306, filed on Jun. 5, 2024.
(60) Provisional application No. 63/656,311, filed on Jun. 5, 2024.
(60) Provisional application No. 63/656,320, filed on Jun. 5, 2024.

(51) Int. Cl. G01N 21/01

(52) U.S. Cl. CPC G01N 21/01; G01N 2021/0193; G01N 2201/0221; G01N 2201/0664

(57) ABSTRACT

Devices, systems, and methods may be utilized for analyzing a reactant array positioned along a first optical path or a second optical path. An example device may include a housing and an imaging system within the housing. The imaging system may include the first optical path and the second optical path. The imaging system may be configured to capture an image for analysis along one or both of the first optical path and the second optical path.

### CROSS REFERENCE TO RELATED APPLICATIONS

This application is a continuation of International Application No. PCT/US2024/058789, filed Dec. 6, 2024, which claims priority to U.S. Provisional Patent Application No. 63/607,926, filed Dec. 8, 2023; U.S. Provisional Patent Application No. 63/607,936, filed Dec. 8, 2023; U.S. Provisional Patent Application No. 63/621,024, filed Jan. 15, 2024; U.S. Provisional Patent Application No. 63/656,306, filed Jun. 5, 2024; U.S. Provisional Patent Application No. 63/656,311, filed Jun. 5, 2024; and U.S. Provisional Patent Application No. 63/656,320, filed Jun. 5, 2024. The disclosures of the foregoing applications are incorporated herein by reference in their entireties.

### TECHNICAL FIELD

The present disclosure pertains to sensing and analysis tools, and the like. More particularly, the present disclosure pertains to devices and systems for sensing and analyzing chemical substances, and methods for manufacturing and using such devices.

### BACKGROUND

A wide variety of devices have been developed for collection, storing, sensing, and analysis of samples. These devices are manufactured by any one of a variety of different manufacturing methods and may be used according to any one of a variety of methods. Of the known medical devices and methods, each has certain advantages and disadvantages.

### BRIEF SUMMARY

This disclosure provides design, material, manufacturing method, and use alternatives for sensing and analysis devices. Although it is noted that collection, storing, sensing, and analysis approaches and systems are known, there exists a need for improvement on those approaches and systems.

An example handheld system may include a flow cell, the flow cell includes a reactant array, an input port, an output port, and a pump component between the input port and the output port and a portable unit for analyzing the reactant array when the flow cell is received in the portable unit, wherein the portable unit may be configured to analyze the reactant array when the flow cell is received in the port unit and analyze a remote reactant array spaced from the portable unit.

In another example, a handheld system may include a flow cell, the flow cell includes a reactant array and a portable unit for analyzing the reactant array when the flow cell is received to the portable unit, wherein the portable unit may be configured to analyze the reactant array when the flow cell is received in the portable unit or analyze a remote reactant array spaced from the portable unit.

Alternatively or additionally to any of the examples in this section, the flow cell may have an input port and output port.

Alternatively or additionally to any of the examples in this section, the remote reactant array may have an input port and output port.

Alternatively or additionally to any of the examples in this section, a pump component may be between the input port and the output port.

In another example, a handheld system may include a flow cell, the flow cell may include a reactant array, an input port, an output port, and a pump component between the input port and the output port, and/or the handheld system may include a substrate, the substrate may include a reactant array, an input port, an output port, and a pump component between the input port and output port, wherein the portable unit may be configured with at least one optical imaging pathway for analyzing reactant arrays of the flow cell and/or the substrate received in the portable unit or remote.

In another example, a handheld system may include at least one optical imaging pathway to analyze an internal and remote reactant array, wherein the portable unit may be configured to receive a flow cell within and/or a remote substrate.

In another example, a handheld system may include a reactant array and a portable unit for analyzing the reactant array when received to the portable unit, wherein the portable unit may be configured to analyze the reactant array.

In another example, a device may include a housing and an imaging system within the housing. The imaging system may include a first optical path and a second optical path. The imaging system may be configured to capture an image for analysis along one or both of the first optical path and the second optical path.

Alternatively or additionally to any of the examples in this section, the device may include a controller in communication with the imaging system, wherein the controller may be configured to analyze the image captured.

Alternatively or additionally to any of the examples in this section, the image captured may include an image of a reactant array.

Alternatively or additionally to any of the examples in this section, the housing may be configured to receive a substrate for imaging at a first location in optical communication with the first optical path and at a second location in optical communication with the second optical path.

Alternatively or additionally to any of the examples in this section, the first location may be a location interior of the housing and the second location is a location exterior of the housing.

Alternatively or additionally to any of the examples in this section, the imaging system may include one or more illumination sources configured to illuminate along the first optical path and the second optical path.

Alternatively or additionally to any of the examples in this section, the device may include an optical relay along the second optical path.

Alternatively or additionally to any of the examples in this section, the device may include one or more holders configured to receive a substrate along one or both of the first optical path and the second optical path.

Alternatively or additionally to any of the examples in this section, the device may include a cover configured to block an opening through the housing along the second optical path.

Alternatively or additionally to any of the examples in this section, the device may include a door configured to block an opening through the housing through which a substrate is received at location within the housing.

Alternatively or additionally to any of the examples in this section, the device may include a detector configured to detect a presence of a substrate along one of the first optical path and the second optical path.

In another example, a system may include a substrate comprising a reactant array, a portable unit comprising a first optical path, a second optical path, and an imaging system configured to capture an image of the reactant array along one of the first optical path and the second optical path.

Alternatively or additionally to any of the examples in this section, the portable unit may be configured to analyze the reactant array in the image captured.

Alternatively or additionally to any of the examples in this section, the portable unit may further include a housing that houses the imaging system, wherein the housing may be configured to receive the substrate along an interior of the housing at a location in communication with the first optical path and receive the substrate at a location exterior of the housing and in communication with the second optical path.

Alternatively or additionally to any of the examples in this section, the portable unit may comprise a detector configured to detect a presence of the substrate.

Alternatively or additionally to any of the examples in this section, the imaging system may comprise one or more illumination sources configured to illuminate along the first optical path and the second optical path.

Alternatively or additionally to any of the examples in this section, the substrate may comprise a dome-shaped configuration having an interior surface and an exterior surface with the reactant array positioned on the interior surface.

Alternatively or additionally to any of the examples in this section, the substrate may comprise a two-dimensional surface with the reactant array positioned on the two-dimensional surface.

Alternatively or additionally to any of the examples in this section, the substrate may comprise a code configured to be detected by the portable unit.

In another example, a method of analyzing a reactant array may include receiving the reactant array at a reader device, wherein the reader device comprises a first optical path and a second optical path, and analyzing the reactant array along one of the first optical path and the second optical path.

Alternatively or additionally to any of the examples in this section, the method may further include imaging the reactant array along one of the first optical path and the second optical path, wherein analyzing the reactant array may comprise analyzing an image resulting from imaging the reactant array.

Alternatively or additionally to any of the examples in this section, the method may further include detecting the reactant array along one of the first optical path and the second optical path, wherein analyzing the reactant array may comprise analyzing the reactant array along the one of the first optical path and the second optical path at which the reactant array is detected.

Alternatively or additionally to any of the examples in this section, detecting the reactant array along one of the first optical path and the second optical path may comprise detecting a code proximate the reactant array.

Alternatively or additionally to any of the examples in this section, detecting the reactant array along one of the first optical path and the second optical path may comprise sensing the reactant array with a sensor.

Alternatively or additionally to any of the examples in this section, the first optical path may be configured to be used for analyzing the reactant array when the reactant array is detected within the reader device and the second optical path may be configured to be used for analyzing the reactant array when the reactant array is detected at a location exterior of the reader device.

Alternatively or additionally to any of the examples in this section, analyzing the reactant array may comprise collecting light from the reactant array and analyzing the light collected.

Alternatively or additionally to any of the examples in this section, the method may include detecting whether the reactant array has been analyzed a first time and preventing the reactant array from being analyzed a second time.

The above summary of some example configurations is not intended to describe each disclosed configuration or every implementation of the present disclosure. The Figures, and Detailed Description, which follow, more particularly exemplify these configurations.

### BRIEF DESCRIPTION OF THE DRAWINGS

The disclosure may be more completely understood in consideration of the following detailed description in connection with the accompanying drawings, in which:

FIG. 1 is a schematic diagram of an illustrative analysis system;

FIG. 2 is a schematic diagram of an illustrative computing system;

FIG. 3 is a schematic diagram of an illustrative analysis system;

FIG. 5 is a schematic diagram of an illustrative analysis system in a hand of a user;

FIG. 8 is a schematic perspective view of an illustrative substrate;

FIGS. 9A and 9B depict a schematic perspective view and a schematic bottom view, respectively, of an illustrative substrate;

FIG. 4 is a schematic diagram of an illustrative portable reader;

FIG. 6 is a schematic diagram of an illustrative substrate having a flow cell configuration;

FIG. 7 is a schematic diagram of an illustrative substrate having a cartridge configuration;

FIG. 10 is a schematic diagram of an illustrative imaging system;

FIG. 11 is a schematic diagram of an illustrative method of using an analysis system;

FIGS. 12A and 12B are schematic diagrams of an illustrative technique for imaging and illuminating an intimate and remote reactant array;

FIG. 13 is a schematic diagram of an illustrative technique for imaging and illuminating an intimate and remote reactant array;

FIG. 14 is a schematic diagram of an illustrative technique for imaging and illuminating an intimate and remote reactant array;

FIGS. 15A and 15B are schematic diagrams of an illustrative technique for imaging and illuminating an intimate and remote reactant array; and

FIGS. 16A and 16B are schematic diagrams of an illustrative technique for imaging and illuminating an intimate and remote reactant array.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

The term “fluid” is inclusive of both liquids and gases.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “a configuration”, “some configurations”, “other configurations”, etc., indicate that the configuration described may include one or more particular features, structures, and/or characteristics. However, such recitations do not necessarily mean that all embodiments include the particular features, structures, and/or characteristics. Additionally, when particular features, structures, and/or characteristics are described in connection with one configuration, it should be understood that such features, structures, and/or characteristics may also be used in connection with other configurations whether or not explicitly described unless clearly stated to the contrary.

The following detailed description should be read with reference to the drawings in which similar structures in different drawings are numbered the same. The drawings, which are not necessarily to scale, depict illustrative configurations and are not intended to limit the scope of the disclosure. Additionally, it should be noted that in any given figure, some features may not be shown, or may be shown schematically, for clarity and/or simplicity. Additional details regarding some components and/or method steps may be illustrated in other figures in greater detail. The devices and/or methods disclosed herein may provide a number of desirable features and benefits as described in more detail below.

Fluids with concentrations of volatile compounds (e.g., volatile organic compounds (VOCs)) and/or gasses, which may or may not be hazardous, may be sensed, analyzed, and/or monitored. Sensing, analyzing, and/or monitoring of fluids with analytes (e.g., non-volatile or volatile compounds, gases, liquids and/or other fluids) may utilize images, light absorption, and/or light reflectance measurements of reactants exposed to such fluids for any purpose including, but not limited to, diagnostic hazard warning, manufacturing processes or quality control, record keeping, archival purposes, product development, product-consumer matching, etc.

In some cases, VOCs and/or gasses may be present in ambient fluid (e.g., ambient air, etc.) and sensed, analyzed, and/or monitored using reactants for real-time alarms, to treat subjects, or to collect and/or archive data for health records, regulatory compliance records, etc. Further, VOCs and/or gasses exhaled or emitted, excreted, emanated, released, and/or secreted from a subject (e.g., humans, animals other than humans, food, produce, meat, pathogens, bacteria (e.g., good and/or bad bacteria), plants, wounds, ulcers, surgical sites, skin of a subject, mouth of a subject, nasal passages of a subject, sinuses of a subject, rectum area of a subject, vaginal area of a subject, genitals area of a subject, ear canals of a subject, pores of a subject, etc.) may be sensed, analyzed, and/or monitored to assess hazardous, dangerous, or illegal substances in or at the subject or target site, a lung condition of lungs of a subject, a condition of a blood disease, a condition of infections, conditions related to diseases or biological conditions, metabolic state, conditions related to general health, conditions related to a response to treatment or therapy, conditions related to food flavors, conditions related to perfumes or smells, and/or other suitable conditions.

The systems discussed herein for sensing, analyzing, and/or monitoring fluids (e.g., for analytes of interest) may be configured to accurately detect and record a reactant array (e.g., a reactant array of or forming a colorimetric sensor array (CSA) or other suitable reactant array) response to exposure to the fluids. The systems may utilize techniques for non-invasively detecting one or more analytes of interest (e.g., one or more pathogens responsible for specific human skin infections including, but not limited to, skin infections, urinary tract infections (UTIs), vaginitis, wound infections, ulcers, etc., and/or other suitable analytes) from a fluid using a CSA to allow for early detection of and early implementation of protocols to address one or more conditions associated with any sensed analytes of interest. For example, the systems may be configured to non-invasively detect one or more analytes of interest (e.g., pathogens, metabolites, etc.) responsible for conditions (e.g., specific human skin infections, urinary tract infections (UTIs), vaginitis, wound infections, ulcers, health, age, response to a treatment or therapy, etc.) of a subject. In one example, enhanced classification of one or more analytes using the systems described herein may enable detection and identification of responsible pathogens at the very beginning stages of a dangerous skin infection, which may result in a high level of protection and probability of a favorable outcome for subjects.

An analysis system (e.g., a reactant array or CSA analysis system) may include a reactant array (e.g., a substrate or CSA having a reactant array) and a reader device (e.g., an analysis unit) for reading or otherwise analyzing the reactant array before, during, and/or after the reactant array is exposed to a fluid. The reader device may be or may include one or more light or image sensors, and/or other suitable image or light collectors/sensors. In some instances, the reader device may be configured to be a handheld or a benchtop device. Further, the reader device may be configured to be simple to use, minimize human error, reduce cross contamination of samples, and reduce human risk of exposure to analytes received at the device.

In operation, a substrate containing the reactant array may be placed into and/or in optical communication with the reader device for analyzing the reactant array (e.g., via an opening in the device) during and/or through pre and post exposure to fluid for optimal reactant array image/reflectometer analysis. That is, analysis of the reactant array may include analyzing the reactant array prior to exposure to the fluid, during exposure to the fluid, and/or after exposure to the fluid is complete. Once the analysis of the reactant array is complete, the substrate with the reactant array may be removed from optical communication with the device. The analysis system may be utilized as a point of care diagnostic in hospital/clinic settings, in food processing plants, for detection of food-borne diseases, for determining an environment's chemical risks/burdens, such as hospital-acquired infections, used in shipping containers to monitor environment during transit; and other suitable environments or application that sensing of fluids is needed.

The substrate may be any suitable component including one or more reactant arrays and that may be configured to expose the one or more reactant arrays to fluids from a target area or site. In one example, the substrate may be a monolithic or cartridge component having the reactant array thereon. In one example, the substrate may be or may be part a flow cell and may have an input port for receiving fluid (e.g., a fluid from a target area or site) to pass over and/or through the one or more reactant arrays and an output port for outputting the fluid passed through and/or over the one or more reactant arrays. In one example, the substrate may be configured to receive a specimen including a sample from a target area or site. Example suitable substrates or flow cells include, but are not limited to, those described in, PCT Application No. PCT/US23/83076, entitled DEVICES, METHODS, AND SYSTEMS FOR MEASURING AND RECORDING A REACTANT ARRAY, filed on Dec. 8, 2023, which is hereby incorporated by reference in its entirety for any and all purposes.

The reader device may have any suitable configuration configured to read and/or otherwise analyze the reactant array before, during, and/or after the reactant array is exposed to a fluid. In some examples, the reader device may include a housing (e.g., a light-tight housing defining a compartment, such as a light-tight compartment, etc.), a light or image sensor, an illumination source for illuminating a surface of a target area to be imaged or sensed, and/or a computing system or controller. The illumination source may be located within and/or exterior of the housing to provide broad-spectrum light uniformly (no specular reflection, Lambertian) on a surface of the target area, but other suitable configurations of the illumination source are contemplated. In one example configuration of the reader device, the light or image sensor may be a digital single-lens reflex (DSLR) camera, where an adjustable lens of the DSLR camera may be located at a first side of the housing and a target of interest (e.g., a reactant array and/or other suitable target of interest) may be located at a second side opposing the first side of the compartment. In one example configurations of the reader device, the reader device may include a housing, a light or image sensor, a first optical path configured to be used to analyze a reactant array received within the housing, a second optical path configured to be used to analyze a reactant array exterior of the housing, and the illumination source.

When the analysis system includes a DSLR camera as the light or image sensor, an adjustable lens of the DSLR camera may have a focus set to image the surface of the target, which then becomes an electronically captured and stored image that may be processed with a computing system (e.g., hardware and software, which may or may not be customized). The computing system of the analysis system may be incorporated into the DSLR camera, the computing system may be entirely separate from, but in wired or wireless communication with the DSLR camera, or the computing system may be partially incorporated into the DSLR camera and partially separate from the DSLR camera.

The analysis system may be configured to capture images of responses/reactions/absorptions of one or more reactant arrays (e.g., where the reactant array may include one or more reactants formed of chemical formulations) to exposure to fluids (liquid or gas). The responses/reactions/absorptions may be captured in or from the image(s) as colors (e.g., red, green, blue, and/or other suitable colors) or in monochrome and intensity information reflected/absorbed by the reactant array. The images may be a snapshot in time or a series of snapshots (e.g., a movie) over time. Using an analysis system with the DSLR camera and/or other suitable multi-dimensional imaging systems instead of, for example, a 1-dimensional contact imaging system, may provide a much larger area for imaging and detection. This larger imaging area may facilitate the use of multiple chemical formulations for the reactants of the reactant array in varying patterns, sizes and shapes to allow for visual identification of the target area being imaged, the placing and/or use of fiducials for color calibration and registration, the use of QR or bar codes, the use of advanced (e.g., AI) image processing techniques, and/or facilitate the use of other important information (e.g., lot #, dates, etc.) that may be captured from the target area and that may aid in the traceability of archived images.

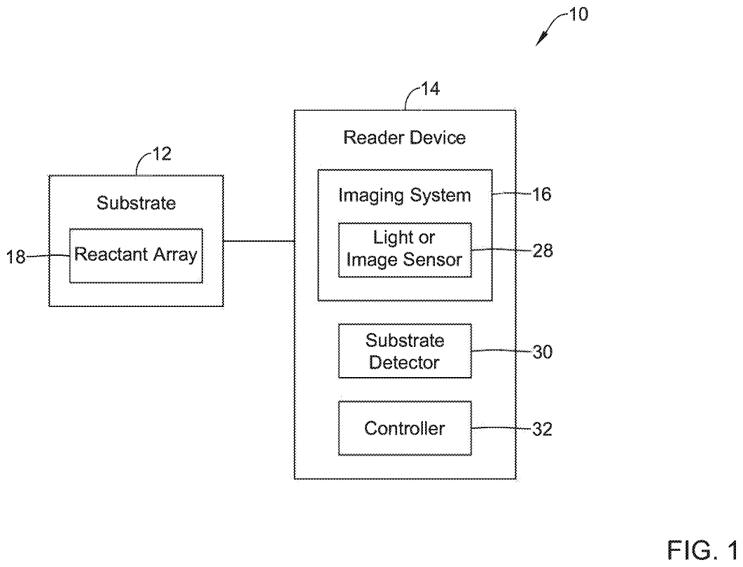

Turning to the Figures, FIG. 1 depicts a schematic diagram of an illustrative system 10 for analyzing a reactant array. Among other components the system 10 may include a substrate 12 having the reactant array 18 and a reader device 14 configured to monitor and/or analyze the reactant array 18.

The substrate 12 may have any suitable configuration and may include any suitable components configured to facilitate the reactant array 18 interacting with a fluid of interest. Example components of the substrate 12 include, but are not limited to, one or more reactant arrays 18, a support structure, a planar surface supporting the reactant array(s) 18, a non-planar surface supporting the reactant array(s) 18, a baffle, a standoff, one or more compartments, one or more locks, one or more specimen detectors, a housing, a window for viewing the reactant array 18, a blade, gasket, one or more access openings extending between the compartments and exterior of the housing, one or more valves configured to seal the access opening, one or more doors or lids, one or more pumps for pumping fluid of interest to the reactant array 18, one or more fluid paths or passages, one or more optical paths, tubing, one or more diaphragms or membranes, one or more single-use components, and/or other suitable components.

The substrate 12 may be formed from any suitable material. Example suitable materials for the substrate 12 include, but are not limited to, polymers, metals, glass, natural fibers, and/or other suitable types of materials.

The substrate 12 may have any suitable shape and/or size configured to support the reactant array 18 or facilitate exposing the reactant array 18 to a fluid of interest. For example, the substrate 12 may have a cube shape, an elongate shape, a rectangular shape, an oval shape, a rounded shape, a circular shape, a cup shape, a ball shape, and/or other suitable shape.

In some cases, the substrate 12 may be reusable. For example, in instances when the reactant array 18 and/or other components of the substrate 12 that may be spent or contaminated with a received fluid, the reactant array 18 and/or other spent or contaminated components of the substrate 12 may be removed from the substrate 12 and the remaining components of the substrate 12 may be reused after cleaning, as needed. In some cases, the reactant array 18 may include reversible reactant material and the reactant array 18 may be reused with other components of the substrate 12.

The reactant array 18 may be any suitable array of one or more reactants (e.g., analyte sensitive material) and the reactants of the reactant array 18 may be formed from any suitable material. In some examples, the reactant array 18 may be configured to be supported by or housed within the substrate 12. In some cases, the reactant array 18 may be part of or form a colorimetric sensor array (CSA), but other suitable configurations are contemplated. When the reactant array 18 forms or is otherwise part of a CSA, the substrate 12 may or may not be part of the CSA. Additionally or alternatively, the reactant array 18 may be formed by applying the material of the reactants to a planar or non-planar surface of the substrate 12.

The material of the reactants of the reactant array 18 may be reversible (e.g., reusable), semi-reversible, or non-reversible (e.g., single use). In some examples, the material of the reactants may be an optically responsive chemical material (e.g., a chemoresponsive material) that changes color in response to detecting one or more analytes (e.g., volatile compounds gasses, liquids, and/or other fluids) in a fluid to which the reactants are exposed, but other suitable material is contemplated. Example suitable materials for reactants include dyes from, but not limited to, the following classes: Lewis acid/base dyes (e.g., metal containing dyes), Brensted acidic or basic dyes (e.g., pH indicators), dyes with large permanent dipoles (e.g., solvatochromic dyes), redox responsive dyes (e.g., metal nanoparticle precursors), and/or other suitable classes of dyes. One example material for the reactants may be a silver nanoparticle material. Other suitable materials for the reactants are contemplated, including reactant material other than a printed dye or an optically responsive chemical material.

The reactants of the reactant array 18 may be applied to the substrate 12 in any suitable manner. In one example, the reactants may be applied to the substrate 12 by printing the reactants (e.g., the material of the reactants) on the substrate 12. When printed, any suitable printing techniques may be utilized including, but not limited to, pin transfer, inkjet, silkscreen, and/or other suitable application techniques.

The reactants of the reactant array 18 may be applied to the substrate 12 randomly and/or to form one or more patterns. Example configurations of the reactants of the reactant array 18 applied to the substrate 12 include, but are not limited to, continuous patterns, partition patterns, segmented patterns, perforated patterns, dots, strips, grid patterns of rows and columns, concentric rings, color matching of a color of printed dye material with a color of a substrate material prior to interactions of the reactants with analyte, patterns that result in identifiable shapes when the analyte sensitive material reacts to a particular analyte, other suitable configurations, and/or combinations thereof.

The reader device 14 may include one more suitable components for reading and/or analyzing the reactant array 18. Example suitable components of the reader device 14 include, but are not limited to, an imaging system 16, light collection components, one or more light or image sensors 28, one or more windows, one or more substrate detectors 30, one or more controllers 32, one or more light sources or illumination components, one or more sets of lenses, one or more motors, one or more pumps, one or more buttons, one or more user interfaces, one or more displays, and/or other suitable components. In some examples, the reader device 14 may be a bench top device or a handheld device. In some cases, the reader device 14 may be isolated from an area of the substrate 12 that is exposed to a fluid of interest and may be configured for reuse.

Although not required, a pump or a pump component may be integrated into the reader device 14 to draw fluids into, over, and/or through the reactant array 18. Furthermore, the pump or a pump component may entirely or at least partially reside in the substrate (as discussed) and actuation of pump may be initiated at the reader device 14 and/or at one or more other suitable locations. In some examples, the pump or pump components may connect to the substrate 12 via one or more ports on a proximal end (inside the reader device 14) and the distal end of the substrate 12 may have one or more port(s) for connecting tubes that may be in fluid communication with a source of fluids. The pump and/or the reader device 14 may include external ports (not shown) that a user may connect to tubing that fluidly couples with a port of the substrate 12, the fluid source, and/or other suitable components. Additionally or alternatively, the reader device 14 and/or the substrate 12 may include one or more components configured to receive a tubing, where a pump or pump component (e.g., a peristaltic pump or pump component and/or other suitable pumps) may interact with the received tubing to draw fluids into, over, and/or through the reactant array.

The reader device 14 may be powered with any suitable power source. Example suitable power sources for powering the reader device 14 include, but are not limited to, battery power in the reader device 14, solar power at the reader device 14, wall or line power, and/or other suitable power sources. In some examples, to facilitate forming the reader device 14 with a handheld configuration, the reader device 14 may be powered by one or more batteries and/or by solar power.

The light or image sensor 28 of the imaging system 16 may be, may include, or may be included in one or more light collectors of any suitable type. Example suitable types of light collectors may include, but are not limited to, a light sensor, an imaging sensor, an n-dimensional sensor array (e.g., where “n” equals 1, 2, etc.), a one-dimensional sensor array, a linear two-dimensional (2D) light detector array image sensor, light detector array image sensor, a photodiode array, a spectrometer, a refractometer, a charge-coupled device (CCD) image sensor, complementary metal-oxide semiconductor (CMOS) image sensor, a fixed imaging sensor, contact image sensor (CIS), color contact image sensor (CCIS), a monochrome image sensor, a camera, a digital single-lens reflex (DSLR) camera, other suitable light collectors, and/or combinations of light collectors. In one example, the light collector may include or may be a spectrometer configured to measure photons collected from (e.g., reflected, transmitted, and/or otherwise received from) the reactant array. Utilizing a spectrometer may facilitate sensing wavelengths of light with high resolution in the nanometer range and may provide a continuous set of data over the wavelength range, which allows for a sensitive analysis of the data to identify components of a fluid to which the reactant array 18 was exposed relative to when other light collectors are used. In another example, the light collector may include a 2D pixel array image sensor configured to record multiple spatial interferograms in a pixel array direction of an interferogram representing a Fourier transform of the reactant array 18, which may provide sufficient sensitivity, while being compact and cost-effective. In another example, the light collector may include or be included in a DSLR camera.

Although a single 2-dimensional sensor array may be utilized as the light or image sensor 28 to sense and/or collect light from the reactant array 18, multiple 1 or 2-dimensional sensor arrays may be additionally or alternatively utilized. The use of multiple sensor arrays may be useful for sensing or collecting light from fixed patterns of the reactant array 18 on the substrate 12, where each pattern may be associated with one array and/or sensing or collecting light from multiple surfaces on the substrate 12 that may need to be imaged. Additionally or alternatively, multiple sensor arrays may be utilized such that one or more sensor arrays may be used to image the reactant array 18 of the substrate 12 that is intimate with or coupled with the reader device 14 (e.g., interior of the housing 42) and one or more sensor arrays may be used to image the reactant arrays 18 that are remote from the reader device 14 (e.g., exterior of the housing 42). Additionally or alternatively, a single n-dimensional sensor array may be used for both intimate and remote imaging by use of varying optical power to cover a broad range of focus. An example single n-dimensional sensor array that may be used for both intimate and remote imaging is disclosed in U.S. Application No. 63/621,024, entitled DEVICES, METHODS, AND SYSTEMS FOR MEASURING AND RECORDING A REACTANT ARRAY, filed on Jan. 15, 2024, is hereby incorporated by reference in its entirety for any and all purposes.

As discussed, the reader device 14 may include one or more substrate detectors 30. In some examples, the substrate detector 30 may be configured to detect when the substrate 12 is proximate and/or received in the reader device 14. In one example, the substrate detector 30 may be a pin or button or other component, where the pin or button or other component physically or mechanically engages the substrate 12 as the substrate 12 is inserted into or positioned at the reader device 14 and in response, the pin or button or other component adjusts and provides a mechanical and/or electrical indication (e.g., completes a circuit, breaks a circuit, etc.) that the substrate 12 has been received. Alternatively or additionally, the substrate detector 30 may be an electronic sensor or detector and/or other suitable type of detector that may provide an indication to the reader device 14 indicating that the substrate 12 is proximate and/or has or has not been received in the reader device 14 (e.g., has or has not been properly received in the reader device 14). In some cases, the electronic substrate detector 30 may sense a signal from the substrate 12 (e.g., an RF signal), sense the substrate 12 breaking a circuit of the reader device 14, completing a circuit of the reader device 14 and/or the substrate 12, and/or sense a presence of the substrate 12 in one or more other suitable manners.

In addition to, as an alternative to, or in combination with the substrate detector 30, the reader device 14 may include a single-use component. The single-use component of the reader device 14 may include a feature configured to electrically, mechanically, or electrically and mechanically modify the substrate 12 such that the substrate 12 will not be used more than once by the reader device 14 (e.g., in more than one test by the reader device 14). Example single-use components include, but are not limited to, a component configured to write to an RFID tag of the substrate 12, a component configured to mechanically alter the substrate 12 to prevent recoupling of the substrate 12 after the substrate 12 has been removed from the reader device 14, or a camera configured to read a code (e.g., a bar code, QR code, alphanumerical code, color code, etc.) on a surface of the substrate 12 or an RFID reader configured to read a code from an RFID of the substrate 12 and add the code or other identifying material to a list of used substrates 12 in memory of the reader device 14 and/or in communication with the reader device 14.

The controller 32 of the reader device 14 may be configured to control operations of the reader device 14 in response to receiving one or more control signals and/or use inputs. The controller 32 may store captured data at the reader device 14 and/or send data to a remote storage component for storage and the controller 32 may use stored captured data to analyze the reactant array 18. Further, the controller 32 may be implemented entirely on the reader device 14, partially on the reader device 14 and partially remotely, or entirely remotely (e.g., on a server or other suitable computing device, on the substrate 12, on a user's mobile device, etc.)

The controller 32 of the reader device 14 may be coupled to one or more other electronic components of the system 10. For example, the controller 32 may be communicatively coupled with one or more of the illumination components, when included, the light or image sensor 28, the cartridge detector 30, the single-use component, and/or one or more other suitable components of the system 10 and/or remote components (e.g., servers, mobile devices, etc.) that may or may not be part of the system 10. In some examples, the controller 32 may be configured to receive an indication to initiate a fluid test (e.g., from a user via a user interface of or in communication with the controller 32, from the cartridge detector, etc.) and send coordinated control signals to one or more electronic components of the system 10.

The controller 32 may be configured (e.g., using advanced algorithms including, but not limited to, machine learning algorithms) to identify or may facilitate identifying one or more components of fluid in contact with the reactant array 18 and/or one or more conditions of a target area based on measured (e.g., sensed and/or calculated) levels of light (e.g., interferograms, images, reflectance, etc.) or changes in light sensed or collected from the reactant array 18 or images of the reactant array 18 captured with the light or image sensor 28. In some examples, the controller 32 may be configured to identify a component of fluid in contact with the reactant array 18 and/or a condition at or of the target area that was a source of the component present in the fluid based on one or more of a timing of levels of light from the reactant array 18, an absolute change between a light or image from the reactant array 18 at a time of or prior to exposure to a fluid of interest and at a predetermined time of or after initially exposing the reactant array to the fluid of interest, and light from or an image of the reactant array 18 relative to predetermined or expected light from or a previous image of the reactant array 18. The controller 32 may be configured to identify the one or more components of the fluid in contact with the reactant array 18 and/or a condition at a location from which the fluid of interest was taken (e.g., a wound, pollen from a flower, an infection, an exhalation from a subject, a sweat gland, etc.) based on light from the reactant array 18 that is received at the light or image sensor 28 in one or more additional or alternative manners.

The controller 32 may use advanced algorithms to predict and/or identify a source of or condition giving rise to the one or more predicted and/or identified analytes being present in the fluid, where the source or condition may be determined by the controller 32 identifying the source or condition as the only known source of the one or more analytes, by the controller 32 identifying the source or condition as the most likely source due to one or more other analytes detected or not detected by the reactant array 18, by the controller 32 identifying the source or condition as the most likely source based on a history of tests of fluid from a similar source and how the reactants of the reactant array 18 have responded to analytes from the particular sources or conditions in the past, and/or identify the source or condition giving rise to the presence of the one or more analytes predicted or identified as being present in the fluid in one or more other suitable manners. In one example, the controller 32 may be configured to identify that a Streptococcus bacteria is a source of or most likely is a source of one or more analytes predicted or identified as being present in a fluid when multiple analytes associated with Streptococcus are predicted or identified as being present in the fluid applied to the reactant array 18.

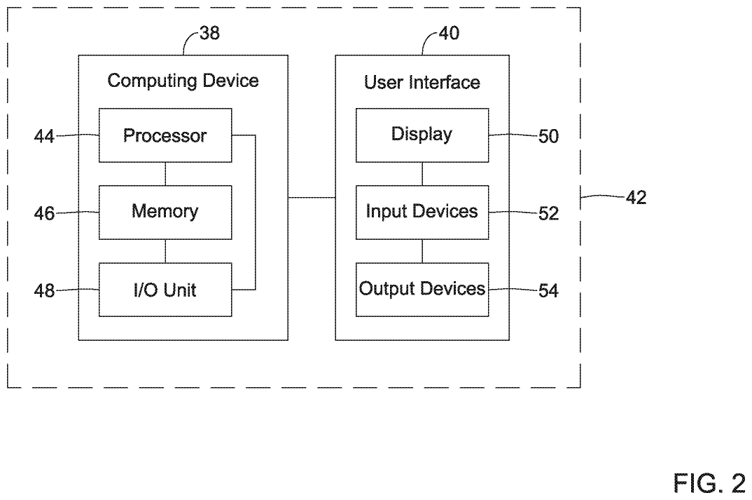

The controller 32 and/or other components of the system 10 may be or may include one or more computing devices including or coupled with one or more user interfaces. FIG. 2 depicts a schematic diagram of an illustrative computing device 38 and a user interface 40, where the computing device 38 and/or the user interface 40 may be entirely or partially housed in one or more housings 42 (e.g., a housing which may or may not house other components of the system 10). The housing 42 may be an optional component, as represented by the broken lines defining the housing 42 depicted in FIG. 2. Although various components are depicted as being included in the computing device 38 and the user interface 40, one more of the depicted components may be omitted and/or one or more additional or alternative components may be utilized.

The computing device 38 may be any suitable computing device configured to process data of or for the system 10 and may be configured to facilitate operation of the system 10. The computing device 38, in some cases, may be configured to control operation of the system 10 by establishing and/or outputting control signals to the light or image sensor 28 and/or other electronic components of the system 10 to run a test on fluid from a target area that interacts with the reactant array 18 and/or monitor results of a test. In some examples, the computing device 38 may be part of the controller 32 and may communicate with other components over a wired or wireless connection, but other suitable configurations are contemplated. When the computing device 38, or at least a part of the computing device 38, is a component separate from a structure of the controller 32, the computing device 38 may communicate with electronic components of the system 10 over one or more wired or wireless connections or networks (e.g., LANs and/or WANs). In some cases, the computing device 38 may communicate with a remote server or other suitable computing device.

The illustrative computing device 38 may include, among other suitable components, one or more processors 44, memory 46, and/or one or more input/output (I/O) units 48. Example other suitable components of the computing device 38 that are not specifically depicted in FIG. 2 may include, but are not limited to, communication components, a touch screen, selectable buttons, and/or other suitable components of a computing device. As discussed, one or more components of the computing device 38 may be separate from the controller 32 and/or incorporated into the components of the controller 32.

The processor 44 of the computing device 38 may include a single processor or more than one processor working individually or with one another. The processor 44 may be configured to receive and execute instructions, including instructions that may be loaded into the memory 46 and/or other suitable memory. Example components of the processor 44 may include, but are not limited to, central processing units, microprocessors, microcontrollers, multi-core processors, graphical processing units, digital signal processors, application specific integrated circuits (ASICs), artificial intelligence accelerators, field programmable gate arrays (FPGAs), discrete circuitry, and/or other suitable types of data processing devices.

The memory 46 of the computing device 38 may include a single memory component or more than one memory component each working individually or with one another. Example types of memory 46 may include random access memory (RAM), EEPROM, flash, suitable volatile storage devices, suitable non-volatile storage devices, persistent memory (e.g., read only memory (ROM), hard drive, flash memory, optical disc memory, and/or other suitable persistent memory) and/or other suitable types of memory. The memory 46 may be or may include a transitory or a non-transitory computer readable medium. The memory 46 may include instructions stored in a transitory state and/or a non-transitory state on a computer readable medium that may be executable by the processor 44 to cause the processor 44 to perform one or more of the methods and/or techniques described herein. Further, in some cases, the memory 46 and/or other suitable memory may store data received from the light or image sensor 28 and/or other components of or in communication with the system 10.

The I/O units 48 of the computing device 38 may include a single I/O component or more than one I/O component each working individually or with one another. Example I/O units 48 may be or may include any suitable types of communication hardware and/or software including, but not limited to, communication components or ports configured to communicate with electronic components of the system 10 and/or with other suitable computing devices or systems. Example types of I/O units 48 may include, but are not limited to, wired communication components (e.g., HDMI components, Ethernet components, VGA components, serial communication components, parallel communication components, status lines (e.g., individual digital/logic levels), control lines (e.g., individual digital/logic levels), component video ports, S-video components, composite audio/video components, DVI components, USB components, optical communication components, and/or other suitable wired communication components), wireless communication components (e.g., radio frequency (RF) components, Low-Energy BLUETOOTH protocol components, BLUETOOTH protocol components, Near-Field Communication (NFC) protocol components, WI-FI protocol components, optical communication components, ZIGBEE protocol components, and/or other suitable wireless communication components), and/or other suitable I/O units 48.

The user interface 40 may be configured to communicate with the computing device 38 via one or more wired or wireless connections. The user interface 40 may include, among other components, one or more display devices 50, one or more input devices 52, one or more output devices 54, and/or one or more other suitable features. Although not depicted, the user interface 40 may include one or more indicators (e.g., light emitting diodes (LEDs), LED linear arrays, numbers, etc.) In some examples, the user interface 40 may be part of or may include the computing device 38. Alternatively or additionally, the user interface 40 may be part of a mobile device or remote computing system.

The display 50 may be any suitable display. Example suitable displays include, but are not limited to, touch screen displays, non-touch screen displays, liquid crystal display (LCD) screens, LED displays, head mounted displays, virtual reality displays, augmented reality displays, a mobile device display, and/or other suitable display types. In some examples, the display 50 may be configured to depict an image captured by the reader device 14 (e.g., captured by the light or image sensor 28). The image may be a live image and/or a photograph or image captured at a previous time. In one example, the image may be a live image of the reactant array 18. Further, the display 50 may display material other than the image including, but not limited to, instructions for testing a fluid, a test status (e.g., a progression of steps in an analysis of the reactant array 18), a system status, results of an analysis of the reactant array 18, marketing indicia, brand indicia, videos, user pictures, art work, etc.

The input device(s) 52 may be and/or may include any suitable components and/or features for receiving user input via the user interface 40. Example input device(s) 52 may include, but are not limited to, touch screens, keypads, mice, touch pads, microphones, selectable buttons, selectable knobs, optical inputs, cameras, gesture sensors, eye trackers, voice recognition controls (e.g., microphones coupled to appropriate natural language processing components) and/or other suitable input devices. In one example, the input devices 52 may include a touch screen that allows for setting set points, initiating a fluid or target area analysis test, adjusting between screens (e.g., a testing screen, a data analysis screen, a results screen, etc.), and/or allows for taking one or more other suitable actions.

The output device(s) 54 may be and/or may include any suitable components and/or features for providing information and/or data to users and/or other computing components. Example output device(s) 54 include, but are not limited to, displays, speakers, vibration systems, tactile feedback systems, optical outputs, and/or other suitable output devices.

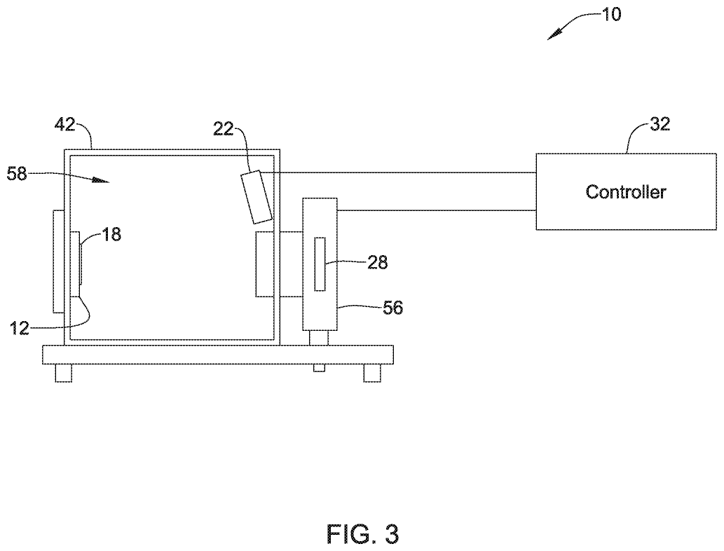

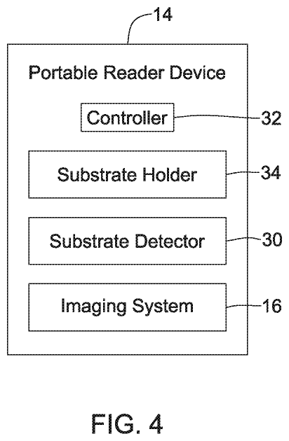

FIG. 3 depicts a schematic diagram of an illustrative configuration the system 10 configured to detect changes caused by a reaction of reactants (e.g., chemicals/formulations/chemosensor, etc.) when the reactants are exposed to fluids. The configuration of the system 10 depicted in FIG. 3 may include a DSLR camera 56 extending into the housing 42 and defining a compartment 58. The DSLR camera may incorporate one or more light or image sensors 28. In addition to and/or as an alternative to using the light or image sensors 28 of the DSLR camera 56, the system 10 may include one or more other suitable light or image sensors 28.

Although other suitable configurations of the housing 42 are contemplated, the housing 42 may have a light-tight configuration preventing external light from entering and the compartment 58 defined by the housing 42 may have a light-tight configuration. Further, within the housing 42, the system 10 may include the substrate 12 with the reactant array 18 configured to be imaged by the DSLR camera 56. In some example configurations, the substrate 12 may be at an opposite side of the housing from a side at which the DSLR camera 56 is located (e.g., at which a lens of the DSLR camera is located). Using advanced algorithms (machine learning, for example), the controller 32 of the system 10 that is in communication with the DSLR camera 56 may predict and/or identify (e.g., using software) analytes to which the reactant array 18 is exposed and/or a source of those analytes with high accuracy based on light and/or images captured by the DSLR camera 56 before, during, and/or after the reactant array is exposed to the fluids.

The substrate 12 may be a flow cell, but other suitable configurations are contemplated. In some examples, the substrate configured as a flow cell may enclose the reactant array 18 and facilitate receiving fluids and directed the received fluids over and/or through the reactants of the reactant array 18.

The system 10 may include one or more illumination sources 22 and the illumination sources 22 may be any suitable type(s) of illumination sources. In some examples, the illumination sources 22 may be located within the housing 42, but other suitable locations of the illumination sources 22 are contemplated. The illumination from the illumination sources 22 could be projected on the target area (e.g., the reactant array 18) using one or more of optical lenses, fiber optics, light pipes, encapsulated LEDs structures alone, and/or other suitable optical components. The illumination from the illumination sources 22 may be applied to the reactant array 18 from behind the substrate 12 (e.g., through an optically transparent substrate 12) and/or from a front of the substrate 12 (e.g., from a side of the substrate 12 at which the reactant array 18 is located).

Example illumination sources 22 include, but are not limited to, broad spectrum (visible range, for example) light emitting diodes (LEDs), discrete wavelength LEDs (400 nm, 600 nm, 700 nm, for example), illumination sources that would create fluorescence, and/or other suitable illumination sources. When utilizing LEDs as part of the illumination source 22, the LEDs may be configured to be turned on or off individually or collectively. Selectively turning on one or more LED and selectively turning one or more LED off (e.g., turning on an individual LED and turning all others off) may facilitate reducing optical noise (crosstalk) while maximizing a reflected/absorbed reactant (e.g., formulation/chemical/etc.) signal of a wavelength of most interest or sensitivity and improving a signal of a weaker responding formulation. Selectively turning on and/or off particular LEDs may allow for choosing specific wavelengths of illumination of the reactants of the reactant array 18 that are ideally suited for specific analytes in the fluid.

In some examples, an illustrative configuration of the system 10 may be or may include a handheld, battery and/or solar (e.g., entirely solar or as an assist) powered, portable reader device 14 that can be used as a diagnostic system where detection of fluids is needed. FIG. 4 depicts a schematic diagram of an illustrative configuration of the reader device 14 having a portable configuration. Although the portable reader device 14 may include additionally and/or alternative components, the illustrative configuration of the reader device 14 depicted in FIG. 4 may include the controller 32, a substrate holder 34, the substrate detector 30, and the imaging system 16. Other suitable configurations of the reader device 14 are contemplated.

In some examples, instead of or in addition to using a DSLR camera with a lens as part of the imaging system 16, a discrete set of optical components (lenses, prisms, etc.) may be used to relay an image of a target (e.g., an image of the reactant array or a portion of the reactant array) onto a focal plane of a 2-dimensional sensor array (CCD/CMOS, for example) to facilitate creating a compact reader device when the reader device 14 is configured to be portable. Alternatively or additionally, the portable configuration of the reader device 14 may include a reflectometer, a spectrometer, and/or other suitable light or image sensor. The optical components may be fixed relative to one another and/or one or more of the optical components may be variable or adjustable with respect to at least one other optical component. When one or more of the optical components is adjustable, a liquid lens or multiple solid lenses may be used to vary a focus. Varying focus may be useful to blur the relayed image (e.g., to cause the relayed image to not be in focus) to create an optical method of averaging the color and detailed information over an area. In some examples, the optical components may include one or more plano-convex lens, plan-concave lens, biconvex lens, concave lens, and/or other suitable types of lenses.

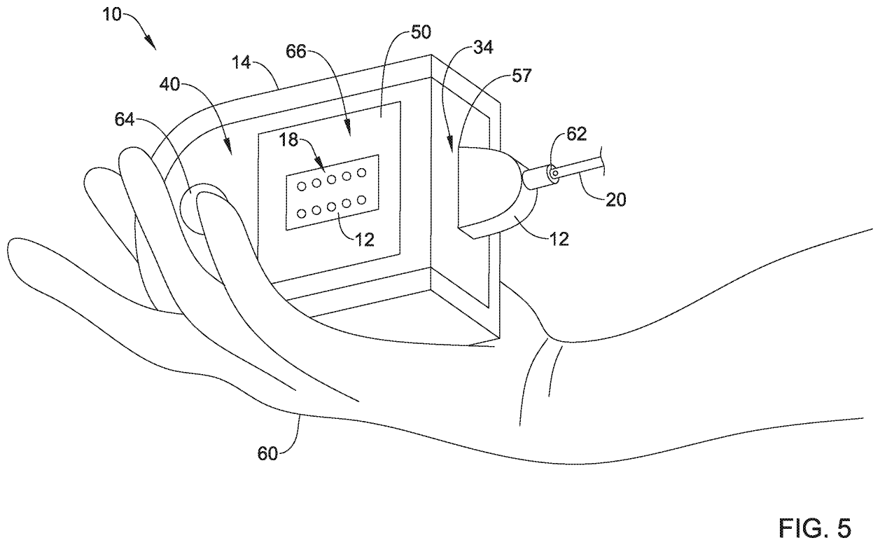

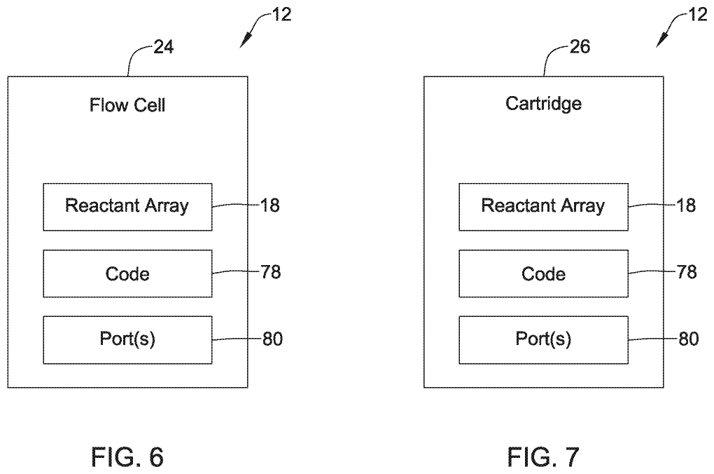

FIG. 5 schematically depicts system 10 having a reader device 14 configured to be portable and held in a hand 60 of a user. Although the system 10 may take on a variety of different handheld configurations (and/or non-handheld configurations), the system 10 depicted in FIG. 5 may include the substrate 12 inserted into the reader device 14 through an access opening 57, which may be or may be part of the substrate holder 34. The substrate 12 may include a specimen 20 inserted through an access opening 62.

The user interface 40 of the reader device 14 depicted in FIG. 5 may include the display 50 and one or more buttons 64. The user interface 40 may include additional and/or alternative components or features including, but not limited to, one or more indicators (e.g., LEDs, LED linear arrays, numbers, etc.) configured to indicate (e.g., as an alert, etc.) a result of a test, a test has been initiated, a test has been completed, a user is to perform an action, an action has been completed, and/or other suitable indications. Additionally or alternatively, the user interface 40 may be on or part of a remote computing device, such as a mobile device, control station, web page, mobile application, and/or other suitable remote computing device. In some examples, the user interface 40 may be entirely omitted from the reader device 14 or one or more components of the user interface 40 discussed herein may be omitted from the reader device 14.

The display 50 (e.g., a touchscreen display or a non-touchscreen display) may depict an image 66 captured by the reader device 14 (e.g., captured by the light or image sensor 28). The image 66 may be a live image and/or a photograph or image captured at a previous time. As schematically depicted in FIG. 5, the image 66 may be a live image of the substrate 12 including the reactant array 18. Alternatively or additionally, the reactant array 18 within the housing 42 may not be visible to a user, may only be visible to the user via a window in the housing 42, and/or may be visible to the user in one or more other suitable manners Further, the display 50 may display material other than the image 66 including, but not limited to, instructions for testing a fluid, a test status (e.g., a progression of steps in an analysis of the reactant array 18), a system status, results of an analysis of the reactant array 18, marketing indicia, brand indicia, videos, user pictures, art work, etc.

The one or more buttons 64 may be selected by a user to cause the reader device 14 and/or the substrate 12 to take one or more actions. For example, a user may interact with the one or more buttons 64 to initiate a pump of the reader device 14 and/or of the substrate 12, power on and/or off the reader device 14, initiate a motor of the reader device 14, initiate an analysis of the reactant array 18, initiate the light or image sensor 28 to take an image or capture light, eject the substrate 12 and/or the specimen 20, mark the substrate 12 used, initiate the display 50, and/or to cause the reader device 14 and/or the substrate 12 to take one or more other suitable actions.

As discussed, the substrate 12 may have any suitable configuration including, but not limited to, a flow cell configuration or a cartridge configuration. FIG. 6 depicts a schematic diagram of an illustrative configuration of the substrate 12 configured as a flow cell 24 having the reactant array 18, a code 78 for identifying the substrate 12 (e.g., a single use code, a batch code, memory device, fiducial, bar code, etc.), and one or more ports 80 for coupling with a fluid flow, but other suitable configurations of the substrate 12 configured as a flow cell 24 with additional or alternative components are contemplated. Although other suitable flow cell 24 configurations of the substrate 12 are contemplated, example configurations of the flow cell 24 configured to be used with or as part of the system 10 are disclosed in PCT Application No. PCT/US23/83073, entitled DEVICES, METHODS, AND SYSTEMS FOR MEASURING AND RECORDING A REACTANT ARRAY, filed on Dec. 8, 2023, which is hereby incorporated by reference in its entirety for any and all purposes, and PCT Application No. PCT/US23/83076, entitled DEVICES, METHODS, AND SYSTEMS FOR MEASURING AND RECORDING A REACTANT ARRAY, filed on Dec. 8, 2023, which has been incorporated by reference herein.

The code 78, in some examples, may be configured to prevent contamination due to reuse of the flow cell. In some cases, the code 78 may be a mechanical, electrical, electromechanical, optical, chemical, magnetic, and/or other suitable type of single-use feature that changes in response to being used with the reader device 14. In one example of the code 78, an electronic single-use component may be imbedded within the substrate 12 and either recognized by the reader device 14 as being intact or broken to indicate whether the substrate 12 is new or has been used, respectively. Example electronic single-use components include, but are not limited to a memory device, radio-frequency identification (RFID) devices, a fuses, and/or other suitable electronic single-use components. When a memory device is used as the code 78, the memory device may be accessed by the reader device 14 and modified by the reader device 14 after the substrate 12 has been inserted into the reader device 14. When a fuse is used as a single-use component (e.g., in addition to or in lieu of the code 78), the fuse may be broken (e.g., via excessive current or in other suitable manners) after the reader device 14 analyzes the reactant array 18, where the reader device 14 may be configured to identify the broken fuse and the substrate 12 with the broken fuse may be prevented from being used in a subsequent analysis. Further, the code 78 may be or may include at least one visual indicator that may change state after use in the reader device 14 and that may be captured by an image capture sequence of the reader device 14, where the reader device 14 may prevent use of the substrate 12 if it determines from the indicator that the substrate 12 has been used.

FIG. 7 depicts a schematic diagram of an illustrative configuration of the substrate 12 configured as a cartridge 26. The cartridge 26 may include the reactant array 18, the code 78, and, optionally, the one or more ports 80, but other suitable configurations of the substrate 12 configured as a cartridge 26 are contemplated.

Although the substrate 12 is not depicted as including a memory device, the substrate 12 may include one or more memory components and the reader device 14 may communicate with the memory device of the substrate 12 to obtain the code 78 and/or learn other details related to the use of the substrate 12. The memory device may be used for a variety of details about the substrate 12 (e.g., versioning, calibration coefficients, date of manufacturing, lot information, classification (e.g., if there are specific substrates 12 for specific target fluid), set a memory location to identify the substrate 12 has been previously used, and/or other suitable details).

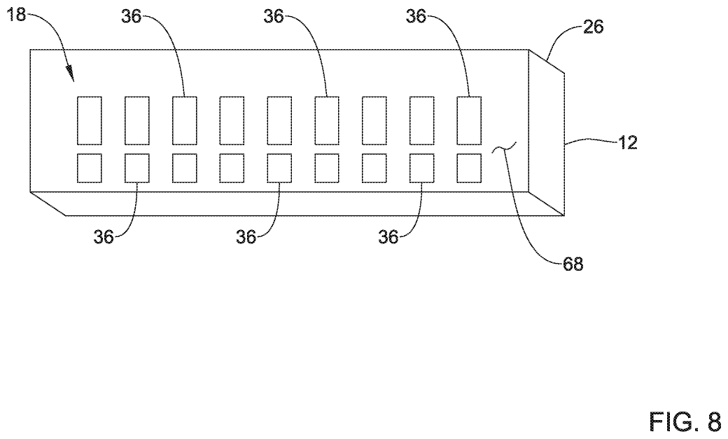

FIG. 8 is a schematic perspective view of an illustrative configuration of a substrate 12. The substrate 12 may include reactants 36 (not all of the reactants 36 are labeled in FIG. 8 for clarity purposes) of the reactant array 18 in one or more linear rows on a two-dimensional or planar surface 68 (e.g., 2 rows, as depicted in FIG. 8). Other suitable configurations of the substrate 12 are contemplated.

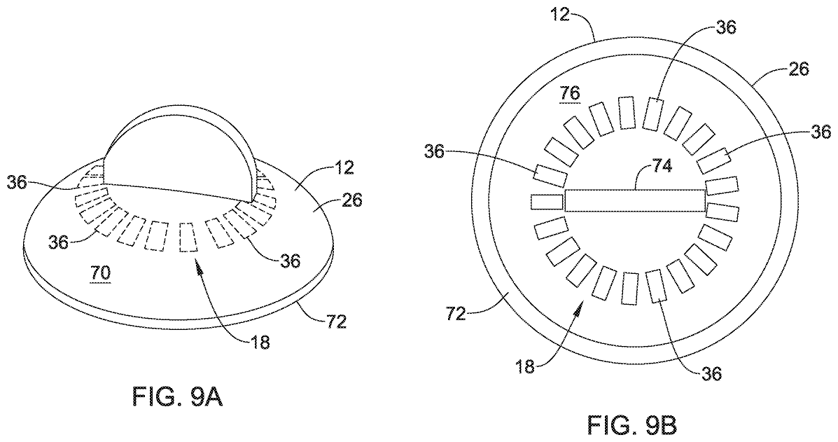

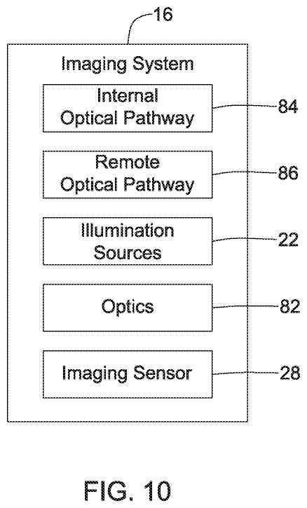

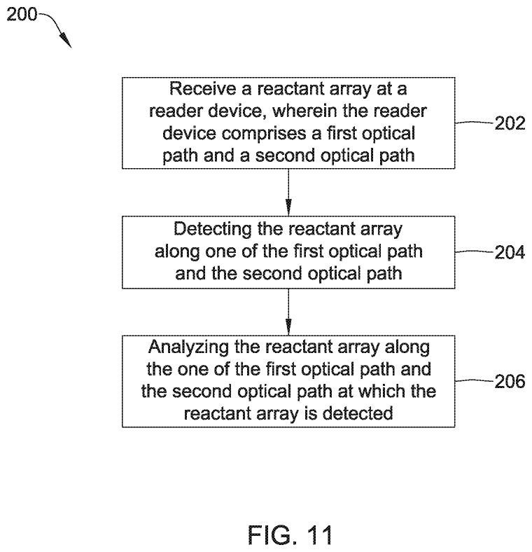

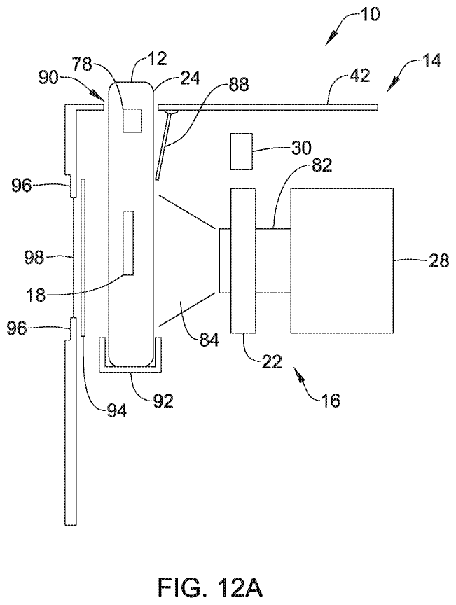

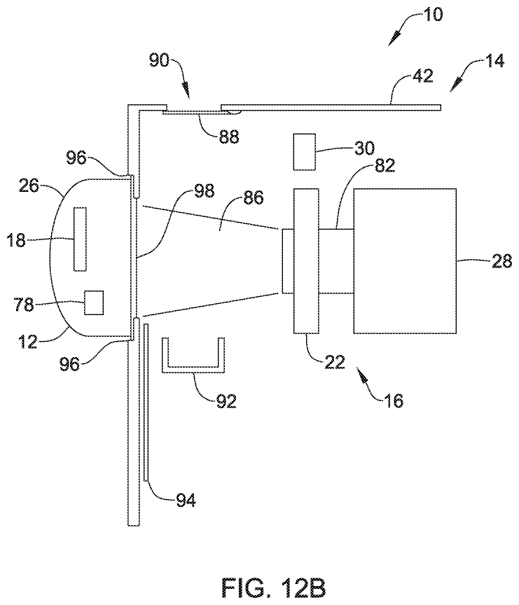

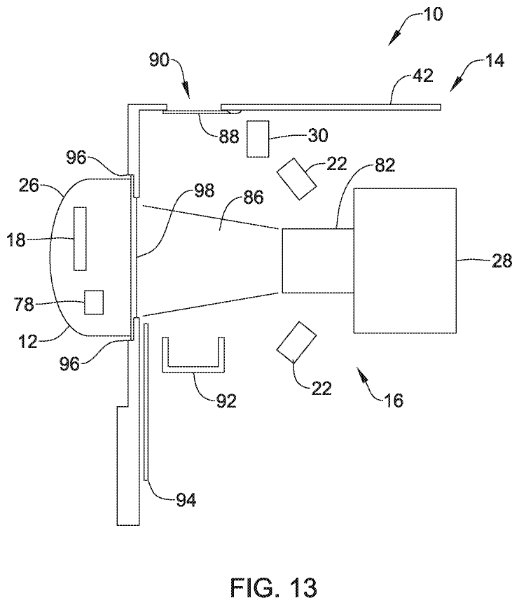

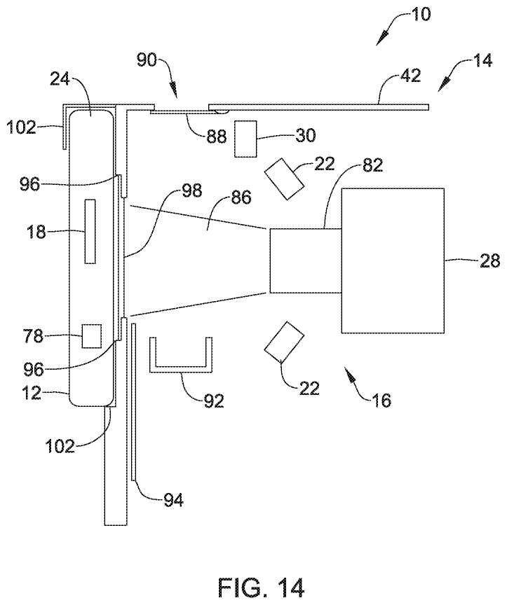

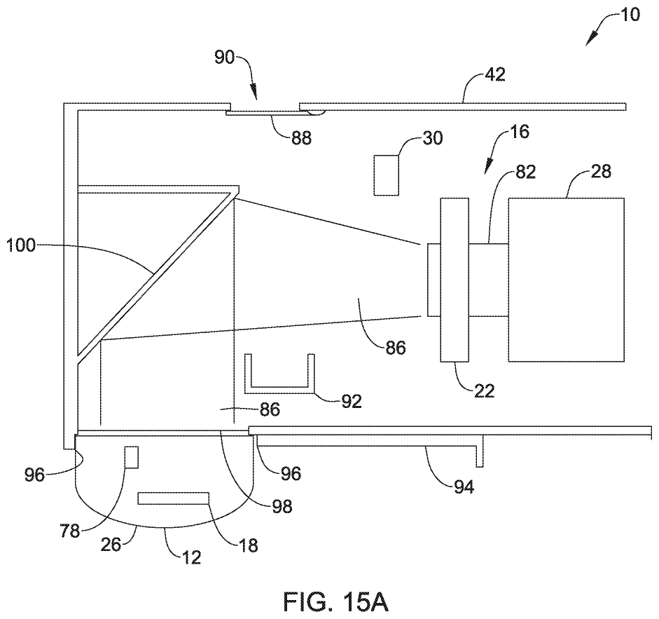

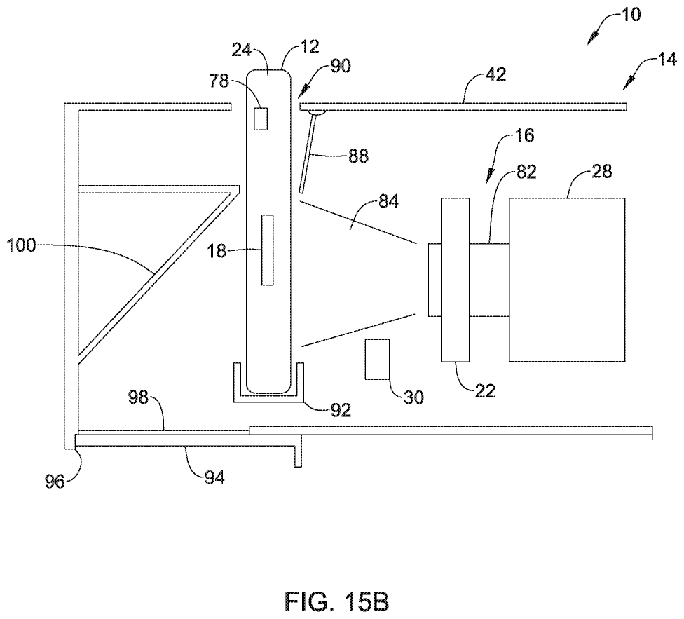

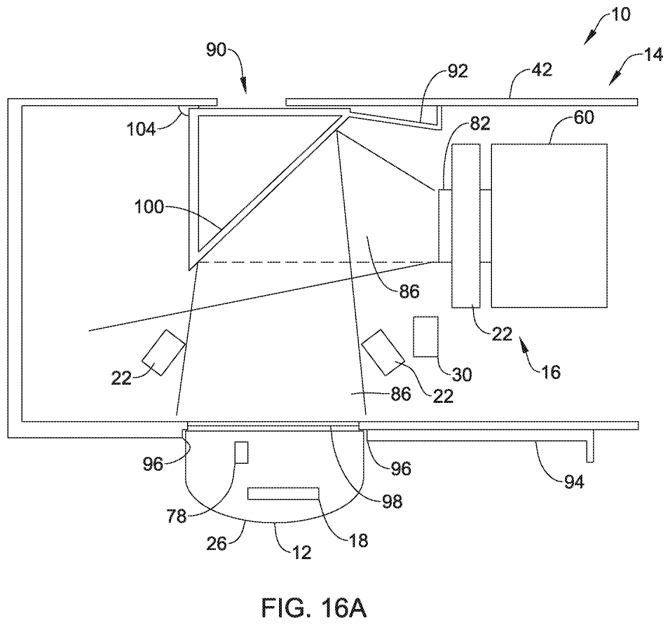

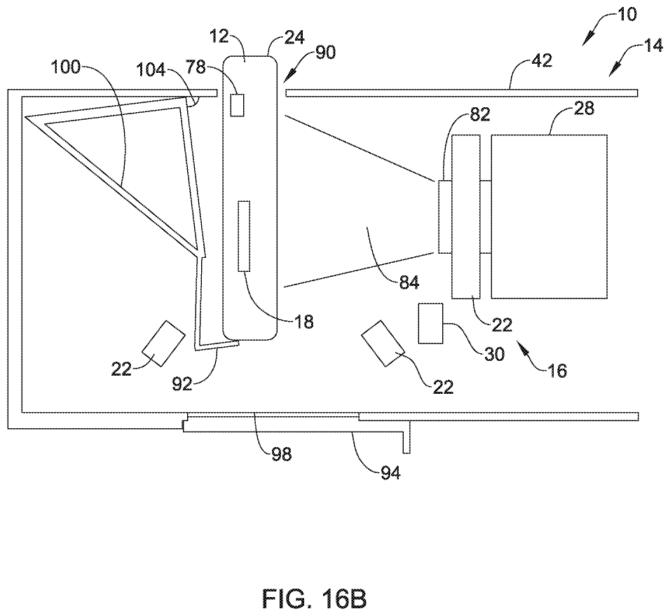

FIG. 9A schematically depicts a perspective of an illustrative configuration of the substrate 12 showing an exterior surface 70 of the substrate 12 having a domed shape with an outer edge 72. The reactant array 18 is depicted in broken lines as the reactants 36 of the reactant array 18 on an interior surface of the substrate 12 (not all of the reactants 36 of the reactant array 18 labeled in FIG. 9A for clarity purposes. The substrate 12 may include a handle 74 for grasping by a user and/or a tool.

FIG. 9B schematically depicts a bottom view of the substrate 12, where the reactant array 18 is configured as an annular array of the reactants 36 on the interior surface 76 of the dome-shaped substrate 12. Although not depicted in FIG. 9B, the reactant array 18 or the substrate 12 may include a single-use component or code for reading by the reader device 14. Other suitable array configurations of the reactants 36 are contemplated.

In operation, the outer edge 72 of the substrate 12 may be placed on a surface around an area that is to be investigated for a presence of one or more analytes of interest (e.g., where the reactants 36 of the reactant array 18 may be configured to react to analytes of interest by changing one or more properties). The dome-shaped configuration of the substrate may concentrate analytes that are at or exuded from the area that is to be investigated within the dome proximate the reactant array 18 to facilitate the analytes reacting with the reactants 36 of the reactant array 18. Other suitable configurations of the substrate 12 are contemplated.

The reader device 14 may be configured to read or analyze the reactant array 18 when the reactant array 18 is placed within or along one of a plurality of imaging paths in communication with the light or image sensor(s) 28 of the reader device 14. In some examples, a first imaging path may be configured to facilitate imaging the reactant array at a location within the housing 42 and a second imaging path may be configured to facilitate imaging the reactant array 18 at a location exterior of the housing 42, but other suitable configurations are contemplated. FIG. 10 depicts a schematic diagram of an illustrative configuration of the imaging system 16 for the reader device 14 configured for imaging both intimate objects (e.g., objects interior of a housing 42) and remote objects (e.g., objects exterior of the housing 42).

The imaging system 16 configured to facilitate intimate and remote imaging of an object may include, among other components, one or more imaging sensors 28, optics or optical components 82 (e.g., as discussed herein or otherwise), a first optical pathway 84 (e.g., an internal optical pathway), a second optical pathway 86 (e.g., a remote or external optical pathway), and one or more illumination sources 22 (e.g., circular ring of light sources around the optics 82, discrete light sources, etc.) for intimate imaging of the reactant array 18. The optical components 82 and/or the first and/or second optical pathways 84, 86 may be fixed relative to one another and/or moveable or adjustable with respect to one another. The illumination sources 22 may be configured to illuminate along the first optical pathway 84, along the second optical pathway 86, and/or at the object (e.g., the reactant array 18).

The optical components 82 may be any suitable components configured to focus an object along the one or more optical pathways of the imaging the system 16 at the light or image sensor 28. The optical components 82 may be fixed with an extended depth of focus allowing both the intimate and remote relayed images to be in focus or a narrow depth of focus optimized to create slight blurring of the intimate and remote image planes that are relayed to the light or image sensor 28. Additionally or alternatively, the optical components 82 independent of or in combination with an optical relay(s) may be variable focus ranges (e.g., linear range, discrete ranges, etc.) controlled by the controller 32, or manually, to further optimize relays of the images onto image sensor 28 and/or to have more than one image plane relayed for each reactant carrier (e.g., each substrate 12), or beyond a surface of the housing 42 through the imaging window 98 of the remote location. Example suitable optical components 82 may include one or more adjustable or non-adjustable lenses. Example suitable lens configurations include, but are not limited to, those discussed in PCT/US2023/083024, filed Dec. 8, 2023, titled DEVICES, METHODS, AND SYSTEMS TO MEASURING AND RECORDING SPECTRUM OF A REACTANT ARRAY, which is hereby incorporated by reference in its entirety for any and all purposes; PCT/US2023/083063, filed Dec. 8, 2023, titled DEVICES, METHODS, AND SYSTEMS TO MEASURING AND RECORDING SPECTRUM OF A REACTANT ARRAY, which is hereby incorporated by reference in its entirety for any and all purposes; PCT/US2023/083068, filed Dec. 8, 2023, titled DEVICES, METHODS, AND SYSTEMS FOR IMAGING, SENSING, MEASURING AND RECODING SPECTRUM, which is hereby incorporated by reference in its entirety for any and all purposes; and U.S. Application No. 63/656,311, filed Jun. 5, 2024, titled DEVICES, METHODS, AND SYSTEMS FOR MEASURING AND RECODING A REACTANT ARRAY, which is hereby incorporated by reference in its entirety for any and all purposes.

The optical paths (e.g., the first optical pathway 84, the second optical pathway 86, etc.) of the reader device 14 may extend through and/or incorporate any suitable components aligned with the light or image sensor 28. For example, the optical paths may include, extend through, or communicate with the optics 82, a window 98, an optical relay, and/or other suitable components. In some examples, the window 98 may be clear, optically transparent, glass, quartz, polarized, filtered, an opening, and/or have one or more other suitable configuration. Although other configurations are contemplated, the window 98 may be in an exterior surface of the housing 42.

The optical relay(s) may have any suitable configuration to facilitate capturing light from or an image of an object along one or more of the optical paths of the reader device 14 and/or direct light to the object. In some examples, the optical relay(s) may be configured to direct the light from or image of the object to the light or image sensor(s) 28 of the reader device 14 and/or direct light from the illumination sources 22 to the object. In some examples, the optical relays may be configured to redirect light in numerous orientations that may overlap, intersect, and/or crossover. Example suitable optical relays include, but are not limited to, a mirrored surface, a beam splitter, a dichroic mirror, a parabolic surface (e.g., for imaging with a wide-angle lens), a parabolic lens, and/or other suitable optical relays. The optical relay(s) may be part of the optics 82 or separate from the optics 82.

FIG. 11 depicts a schematic box diagram of an illustrative method 200 of analyzing a reactant array. In some examples, the method 200 may include using a reader device and/or an imaging system configured to image or collect light from the reactant array at an intimate location and image or collect light from the reactant array at a remote location, as depicted for example in FIGS. 12-16B and/or in other suitable configurations.

An ability to image reactant arrays that are remote from the reader device 14 may be useful, for instance, if the reactant array(s) are placed onto or into an environment of interest. For example, the reactant array(s) may be imaged first by the handheld then placed over/onto/into an infected area of skin or other area for testing to allow the fluids (e.g., volatile or non-volatile fluids) from the infection or area for testing to interact with the reactant array(s). After some period of time, the reactant array(s) may be reimaged by the reader device 14 to assess changes in the reactant array(s) due to the interactions/reactions with the fluids to determine the cause(s) of infection and/or whether an analyte is present at the area for testing.

The method 200 may include receiving 202 a reactant array or a substrate having a reactant array thereon at a reader device. In some examples, the reader device may be a portable reader device. In some examples, the reader device may include at least a first optical pathway, such as an internal optical pathway, and a second optical pathway, such as an external optical pathway. Other suitable configurations of the reader device are contemplated and may be used in the method 200.

In some examples, the reader device (e.g., a portable and/or handheld configuration of the reader device) may be configured to receive or incorporate the substrate or at least a reactant array in the following ways: through an opening in the housing through which the substrate or the reactant array(s) may be inserted (e.g., slid into, etc.); through a lid of the housing that may open (e.g., like a trunk of a car) and receive the substrate or the reactant array(s) through the opening; in one or more pocket/recessed areas or attachment features on an outside of the housing that may facilitate attaching the substrate or the reactant array(s) to the housing; and/or in one or more other suitable manners. The substrate, when included, may include at least one reactant of a reactant array. Once the substrate or at least the reactant array(s) is positioned entirely or at least partially within or at the housing, at least one reactant may be in communication (e.g., optical communication) with the light or image sensor.

The method 200 may include detecting 204 the reactant array and/or the substrate on which the reactant array is located with the reader device along one of the first optical pathway (e.g., the substrate and the reactant array are at least partially within the housing 42 along the first optical pathway) and the second optical pathway (e.g., the substrate and the reactant array are at least partially exterior of the housing along the second pathway). In some examples, the detecting 204 of the reactant array may include using a sensor to detect the reactant array or the substrate on which the reactant array is located, detecting a code on the substrate or in the reactant array (e.g., a code proximate the reactant array, a code in the reactant array, and/or other suitable code), and/or detecting the reactant array in one or more other suitable manners. In some examples, detecting the reactant array with components of the reader device may be omitted.

As part of or separate from detecting the presence and/or location of the reactant array, the reader device may detect whether the reactant array has been analyzed a first time and if so, prevent the reactant array from being analyzed a second time. When the reader device detects the reactant array has been analyzed a first time, the reader device may automatically stop analyzing the reactant array, reject the substrate, initiate an optical, audio, or tactile alarm, and/or take one or more other suitable actions.

The method 200 may include analyzing 206 the reactant array along the one of the first optical pathway and the second optical pathway at which the reactant array was received. When the reader device detects the optical pathway at which the reactant array is received, the analyzing 206 may be performed along the optical pathway at which the reactant array is detected. In some examples, the reactant array may be imaged and/or light from the reactant array may be collected along the one of the first optical pathway and the second optical pathway at which the substrate and/or the react array is located using the imaging system of the reader device. Once the reactant array has been imaged and/or light therefrom has been collected, the image of or light from the reactant array may be analyzed, as discussed herein or otherwise, at or remote from the reader device. In some examples, analysis of the reactant array may include analyzing the reactant array before, during, and/or after exposure of the reactant array to a fluid to be analyzed. In one example, the analysis of the reactant array may include comparing an image of the reactant array before being exposed to fluid to an image of the reactant array after being exposed to fluid. Other suitable analysis techniques are contemplated.

In some examples, the reactant array may be illuminated with one or more illumination sources along the first optical pathway or the second optical pathway at which the reactant array is located. Although illumination of the reactant array is contemplated, one or more of the illumination sources may be turned on or off while imaging or capturing light from the reactant array, as discussed herein or otherwise.

FIGS. 12A and 12B schematically depict an illustrative configuration of the system 10 including the reader device 14 configured to image and/or analyze the reactant array 18 at an intimate location (e.g., a first or interior location) and image the reactant array 18 at a remote location (e.g., a second or exterior location). The configuration of the reader device 14 configured for intimate and remote imaging and/or analysis of the substrate 12 may include, among additional or alternative components, the light or image sensor 28, the optics 82, the illumination sources 22, the housing 42, a door 88 selectively covering an opening 90 for receiving the substrate 12, an interior holder 92 for receiving the substrate within the housing 42, the substrate detector 30, the light or image sensor 28, the optics 82, one or more windows 98 in the housing 42, a cover 94 for covering the window 98, an external holder 96 for receiving the substrate 12 exterior of the housing 42, and/or other suitable components or features. Although the housing 42 is depicted in FIGS. 12A and 12B with only two walls, the housing 42 is only schematically depicted and may be configured to fully enclose the components within the housing 42 in a light-tight manner or other suitable manner.

FIG. 12A schematically depicts illustrative configuration intimate imaging and/or analysis of the reactant array 18, which may include receiving the substrate 12 (e.g., the flow cell 24 configuration of the substrate 12 or the cartridge configuration of the substrate 12) within the housing 42. In some examples, the substrate 12 may be received within the housing 42 by inserting (e.g., pushing) the substrate 12 into the housing 42 through an opening 90 in the housing 42. In some examples, the door 88 (a flap, a slide, a shutter, etc.) may extend across the opening 90 and to open the door 88, when included, a user may push the substrate 12 against the door 88 to adjust the door away from the opening 90. The door 88 may be automated and/or may open in one or more other suitable manners. As the substrate 12 advances through the opening 90, the substrate 12 may be received in, secured in (e.g., locked, latched, held, trapped, etc.), and/or registered within the interior holder 92 (e.g., a recess, a registration, etc.) located in the housing 42 and aligned with the opening 90.

The reader device 14 may include a door detector configured to detect whether the door 88 is opened or closed. The door detector may detect whether the door 88 is in the opened position or the closed position by mechanically, electromechanically, optically, or in one or more other suitable manners detecting the position of the door 88. In some examples, the door detector may determine or may facilitate the system 10 determining (e.g., via the controller 32) if the substrate 12 is in a desired position within the housing 42, if the door is inadvertently left open in a manner that could compromise a light-tight environment of the housing 42, and/or detect one or more other statuses related to a position of the door 88.

The reader device 14 may detect a presence of the substrate 12 by detecting the code 78 using the substrate detector 30, electrically detecting the code 78 using the substrate detector 30, mechanically or electromechanically detecting the substrate 12 using the substrate detector 30, optically detecting the substrate 12 using the imaging sensor 28 or the substrate detector 30, and/or detect the substrate 12 by other suitable means of detection. In some examples, the substrate detector 30 may detect the presence or absence of the substrate 12 in the housing 42 by mechanically, electromechanically, optically, or in one or more other suitable manners detecting the door 88 is in an opened position or closed position, respectively. The internal or first optical pathway 84 and the illumination sources 22 (e.g., light ring, or discrete light sources around optics 82, etc.) may be used to facilitate imaging the reactant array 18 and or other areas and details of the substrate 12.

As depicted in FIG. 12B, the reader device 14 may be configured to image the reactant array 18 at a remote location (e.g., external of the housing 42) using the imaging sensor 28, the optics 82, the illumination source(s) 22, and the second optical pathway 86 for analysis. Although the substrate 12 may be configured as the cartridge 26 having a domed configuration in FIG. 12B, other suitable configurations of the substrate 12, including as the flow cell 24, may be utilized. In some examples, the cover 94 (e.g., an ambient light cover or other suitable cover) may be moved, rotated, opened, or otherwise removed or not present from the second optical pathway 86 when the substrate 12 is placed into, onto, or otherwise at the exterior of the housing 42 and the window 98, and is registered and held (resting, latched, attached, etc.) in place by the exterior holder 96 proximate the exterior of the housing 42. The cover 94 may be adjusted or moved manually or in an automated manner in response to a control signal. In some examples, substrate 12 and the reactant array 18 may be detected by the substrate detector 30, as discussed herein or otherwise, as being located along the second optical pathway 86. Though the remote imaging configuration in FIG. 12B depicts the substrate 12 in contact with the housing 42 of the reader device 14, other implementations not requiring contact are contemplated.

The reader device 14 may include a cover detector configured to detect whether the cover 94 is opened or closed. The cover detector may detect whether the cover 94 is in the opened position or the closed position by mechanically, electromechanically, optically, or in one or more other suitable manners detecting the position of the cover 94. In some examples, the cover detector may determine or may facilitate the system 10 determining (e.g., via the controller 32) if the substrate 12 is in a desired position at the housing 42 or window 98, if the cover is inadvertently left open in a manner that could compromise a light-tight environment of the housing 42, and/or detect one or more other statuses related to a position of the cover 94. The cover detector may be part of or the same component as the door detector, may be used with the door detector, or may be a separate component than the door detector.

FIG. 13 schematically depicts a configuration of the reader device 14 for capturing light from or an image of the reactant array 18 along the second optical pathway 86 similar to the configuration depicted in FIG. 12B, but with the illumination source(s) 22 being discrete light sources (e.g., LED, light pipes, filaments, etc.) that illuminate the object location (e.g., a plane or other location of the reactant array 18 and or reactant and surface of the substrate 12). In some examples, the discrete illumination sources 22 may be placed at an angle, distance, and/or location from the reactant array 18 to eliminate or mitigate specular reflection and illuminate (uniformly or otherwise) an area of interest. The illumination sources 22 may have the same wavelengths, different wavelengths, or any combination thereof. The illumination sources 22 individually, or collectively, may be turned on or off with the controller 32 (not depicted in FIG. 13).

FIG. 14 schematically depicts a configuration of the reader device 14 for capturing light from or an image of the reactant array 18 similar to the configuration depicted in FIG. 13, but with the reactant array on the substrate 12 having the the flow cell 24 configuration. In some examples, the reader device 14 may include the exterior holder 96 (e.g., a first exterior holder device) configured to receive the substrate 12 configured as the cartridge 26, as depicted for example in FIG. 13, and an exterior holder 102 (e.g., a second exterior holder device) configured to receive the substrate 12 configured as the flow cell 24, as depicted for example in FIG. 14, but it is contemplated that the reader device 14 may only include a single exterior holder device that may be configured to hold or otherwise receive one or both of the flow cell 24 configuration of the substrate 12 and the cartridge 26 configuration of the substrate 12. The substrate 12 may be slid into or otherwise positioned, registered, locked, or placed into the exterior holder 102. The ambient cover 94 may be opened, rotated, moved or otherwise removed from the second optical pathway 86 in FIG. 14.

FIGS. 15A-16B are schematic diagrams depicting illustrative intimate and remote imaging configurations of the reader device 14. Some components in FIGS. 15A-16B are similar to the components described with respect to FIGS. 12A-14 and may not be re-described with respect to FIGS. 15A-16B. Although the housing 42 is depicted in FIGS. 15A-16B with only three walls, the housing 42 is only schematically depicted and may be configured to fully enclose the components within the housing 42 in a light-tight manner or other suitable manner.

FIGS. 15A and 15B depict a use of the optical relay 100 for capturing light from or an image of the reactant array 18 at a remote location exterior of the housing 42 along the second optical pathway 86. When the substrate 12 having the flow cell 24 configuration is in place at the interior holder 92 and detected by the substrate detector 30, as depicted in FIG. 15B, the reader device 14 may use the first optical pathway 84 to capture light from or an image of the reactant array 18, where the reactant array 18 may be normal to the optics 82 and the light or image sensor 28. With the substrate not positioned in the interior holder 92, the ambient cover 94 may be opened (e.g., manually or in an automated manner), and the substrate 12 having the cartridge configuration 26 may be attached to and/or otherwise positioned at the exterior holder 96, as depicted for example in FIG. 15A. When the substrate 12 is at the exterior holder 96, the second optical pathway 86 may be used to capture light from or an image of the reactant array 18 and the reactant array 18 may be at 90-degrees or at another suitable angle relative to normal to the optics 82 and the light or image sensor 28. As such, the optical relay 100 may be configured to direct light from the reactant array 18 toward the light or image sensor 28. Though the optical relay 100 is depicted as having a single 45-degree surface, other orientations, surfaces, and techniques are contemplated in which the light from the reactant array 18 or light from the illumination sources 22 to the reactant array is redirected one or more times. In addition to or as an alternative to using the optical relay(s), a plurality of image sensors 28 and/or optics 82 may be used to image the reactant arrays 18 along different optical pathways.

FIGS. 16A and 16B schematically depict the reader device 14 with an illustrative configuration of the optical relay 100 that pivots at a pivot point 104 in response to the substrate 12 (e.g., the substrate 12 in the flow cell 24 configuration) being inserted into the interior holder 92 of the housing 42 and pressing against the interior holder 92 until fully seated and in position where the substrate 12 may intercept or otherwise be positioned in or at the first optical pathway 84. Absent insertion of the substrate 12 through the opening 90, the optical relay 100, for example as depicted in FIG. 16A, may be positioned for remote imaging of reactant array 18 through the second optical pathway 86 (e.g., the optical relay 100 may be biased to a closed position with a biasing mechanism and/or otherwise secured in the closed position).

As depicted in FIGS. 16A and 16B, the illumination sources 22 may be configured as ring illumination sources around the optics 82 and/or discrete illumination sources directed (e.g., directly or indirectly directed via the optical relay 100) toward the reactant array 18 on the substrate 12. Additionally or alternatively, the illumination sources 22 may illuminate the reactant array 18 on the substrate 12 from behind a surface of the optical relay 100 when a dichroic mirror or other suitable technology (e.g., prism, beam splitter, polarizing dichroic, etc.) is used as the surface of the optical relay 100. In one example, the illumination source 22 configured as a ring electrode may extend around the optics 82 and may be configured to directly illuminate the reactant array 18 on the substrate 12 received at the interior holder 92 and/or indirectly illuminate the reactant array 18 on the substrate 12 received at the exterior holder 96 via the optical relay 100. In one example, the illumination sources 22 configured as discrete illumination sources 22 may be configured to directly illuminate the reactant array 18 on the substrate 22 received at the exterior holder 96 and/or indirectly illuminate the reactant array 18 on the substrate 12 received at the interior holder 92 via the optical relay 100 (e.g., through a transparent substrate 12).

Although many of the optical pathways depict the substrate 12 having the cartridge 26 configuration at the remote imaging location and the substrate 12 having the flow cell 24 configuration at the near imaging location, alternative or additional configurations may include placing the substrate 12 with the cartridge 26 configuration at a near imaging location and/or the substrate 12 with the flow cell 24 configuration at a remote imaging location. Other optical pathways and configurations (e.g., multiple mirrors, multiple angular changes, etc.) are contemplated.

The system 10 may be expanded in size and capability beyond that of the portable reader device 14 and the substrate 12 depicted in FIGS. 12A-16B. For example, the system 10 may be expanded by increasing a number of reactant arrays 18 that may be imaged by changing a size of the substrate 12, the location(s) the substrate 12 is placed relative to the reader device 14, a number of reactants or types of reactants of the reactant array(s) 18, by utilizing non-flow cell elements for laboratory (benchtop) uses, and/or by changing sizes of one or more other suitable components.

Example suitable components that be used with or as part of the system 10 include, but are not limited to those described in PCT Application No. PCT/US23/83104, entitled DEVICES, METHODS, AND SYSTEMS FOR MEASURING AND RECORDING A REACTANT ARRAY, filed on Dec. 8, 2023, which is hereby incorporated by reference in its entirety for any and all purposes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless otherwise expressly stated, it is in no way intended that any method or technique set forth herein is to be construed as requiring that its steps be performed in a specific order. This holds for any possible non-express basis for interpretation, including matters of logic with respect to arrangement of steps or operational flow, plain meaning derived from grammatical organization or punctuation, and the number or type of configurations described in the specification.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example configuration being used in other configurations. The invention's scope is, of course, defined in the language in which the appended claims are expressed.

What is claimed is:

1. A device, comprising:
a housing; and
an imaging system within the housing, the imaging system comprising a first optical path and a second optical path, and
wherein the imaging system is configured to capture an image for analysis along one or both of the first optical path and the second optical path.

2. The device of claim 1, further comprising:
a controller in communication with the imaging system, and
wherein the controller is configured to analyze the image captured.

3. The device of claim 1, wherein the image captured includes an image of a reactant array.

4. The device of claim 1, wherein the housing is configured to receive a substrate for imaging at a first location in optical communication with the first optical path and at a second location in optical communication with the second optical path.

5. The device of claim 1, wherein the imaging system comprises one or more illumination sources configured to illuminate along the first optical path and the second optical path.

6. The device of claim 1, further comprising:
an optical relay along the second optical path.

7. The device of claim 1, further comprising:
one or more holders configured to receive a substrate along one or both of the first optical path and the second optical path.

8. The device of claim 1, further comprising:
a cover configured to block an opening through the housing along the second optical path.

9. The device of claim 1, further comprising:
a door configured to block an opening through the housing through which a substrate is received at location within the housing.

10. The device of claim 1, further comprising:
a detector configured to detect a presence of a substrate along one of the first optical path and the second optical path.

11. A system, comprising:
a substrate comprising a reactant array;
a portable unit comprising:
a first optical path;
a second optical path; and
an imaging system configured to capture an image of the reactant array along one of the first optical path and the second optical path.

12. The system of claim 11, wherein the portable unit is configured to analyze the reactant array in the image captured.

13. The system of claim 11, wherein the portable unit further comprises:
a housing that houses the imaging system, and
wherein the housing is configured to receive the substrate along an interior of the housing at a location in communication with the first optical path and receive the substrate at a location exterior of the housing and in communication with the second optical path.

14. The system of claim 11, wherein the portable unit comprises a detector configured to detect a presence of the substrate.

15. The system of claim 11, wherein the imaging system comprises one or more illumination sources configured to illuminate along the first optical path and the second optical path.

16. The system of claim 11, wherein the substrate comprises a dome-shaped configuration having an interior surface and an exterior surface with the reactant array positioned on the interior surface.

17. The system of claim 11, wherein the substrate comprises a two-dimensional surface with the reactant array positioned on the two-dimensional surface.

18. The system of claim 11, wherein the substrate comprises a code configured to be detected by the portable unit.

19. A method of analyzing a reactant array, the method comprising:
receiving the reactant array at a reader device, wherein the reader device comprises a first optical path and a second optical path; and
analyzing the reactant array along one of the first optical path and the second optical path.

20. The method of claim 19, further comprising:
imaging the reactant array along one of the first optical path and the second optical path, and
wherein analyzing the reactant array comprises analyzing an image resulting from imaging the reactant array.
